(19) United States
(12) Patent Application Publication
(10) Pub. No.: US 2012/0077373 A1
(43) Pub. Date: Mar. 29, 2012

(54) KVM SWITCH MODULE

(75) Inventor: Ching-Wei Cheng, Keelung (TW)

(73) Assignee: ACTION STAR ENTERPRISE CO., LTD., New Taipei City (TW)

(21) Appl. No.: 13/216,226

(22) Filed: Aug. 23, 2011

Related U.S. Application Data
(60) Provisional application No. 61/375,896, filed on Aug. 23, 2010.

(51) Int. Cl. H01R 11/05

(52) U.S. Cl. 439/502

(57) ABSTRACT

The present invention relates to an improved KVM switch module for connecting a keyboard and a cursor control device to a plurality of computer hosts with various connector interfaces. The improved KVM switch module comprises a first cable set, a second cable set and a third cable set, wherein the first cable set is coupled to a first computer, the second cable set is coupled to a second computer, and the third cable set is used for switch. In addition, the first cable set includes at least one first USB male connector, at least one first USB female connector, at least one first PS2 male connector, and at least one first PS2 female connector, and the second cable set includes at least one second USB male connector, at least one second USB female connector, at least one second PS2 male connector, and at least one second PS2 female connector.

### CROSS REFERENCE TO RELATED APPLICATION

This application claims priority from a co-pending U.S. provisional patent application Ser. No.: 61/375,896 for “KVM Switch Module”, filed on Aug. 23, 2010, the entire content of which is incorporated by reference.

### BACKGROUND OF THE INVENTION

1. Technical Field

The present invention relates to a KVM switch, and more particularly, to KVM switch module with various connector interfaces for connecting and controlling a plurality of computers.

2. Description of Related Art

There exist devices for interconnecting a single computer to multiple computers. For example, a keyboard/video/mouse (KVM) switch is a device which is used for connecting multiple computers and a single keyboard, video monitor and mouse, such that the connected computers will be controlled by the single keyboard and mouse through the KVM. In this way, a user may have access to multiple computers without having to invest in corresponding keyboards, monitors, and mice for each of the computers. When the user accesses a computer connected to the KVM switch, video signals are routed from the computer, processed, and displayed on the single video monitor.

Please refer to FIG. 1, which illustrates a framework diagram of a conventional KVM switch module according to the U.S. patent with application Ser. No. 12/342,244. As shown in FIG. 1, the KVM switch module 40′ includes a first body 41′, a second body 42′, a plurality of first cables 43′ each having an USB connector plug 44′ and a plurality of second cables 45′ each having a video connector plug 46′. The plurality of first cables 43′ fixedly attached to and extending from the first body 41′ and the plurality of second cables 45′ fixedly attached to and extending from the second body 42′. A first switching circuit contained within the first body 41′ electrically coupled to a first set of connector ports (not shown) switches to connect each of the first set of connector ports to one of the plurality of first cables 43′. A second switching circuit contained within the second body 42′ electrically coupled to a second set of connector port (not shown) switches to connect the second set of connector port to one of the plurality of second cables 45′.

The first set of connector ports are electrically connected to external control devices such as a keyboard and a cursor control device. The second set of connector port is electrically connected to external display device such as an LCD monitor. The USB connector plugs 44′ of the first cables 43′ are electrically connected to corresponding computer hosts and the video connector plugs 46′ of the second cables 45′ are also electrically connected to the corresponding computer hosts. Thus, one of the computer hosts is electrically connected to the keyboard and the cursor control device and the LCD monitor through the first switching circuit within the first body 41′ and the second switching circuit within the second body 42′, respectively.

Because the first set of connector ports are electrically connected to the keyboard and the cursor control device and electrically connected to one of the plurality of the first cables 43′ through the first switching circuit within the first body 41′, the keyboard and mouse control signals controlled by a user can be transmitted to one of the computer hosts through corresponding first cables 43′. Besides, as shown in FIG. 1, the KVM switch module 40′ induces a third cable 47′ for electrically connecting to the first body 41′ and the second body 42′, so that, the user can switch the first switching circuit within the first body 41′ to control the computer host from one to another, and the second switching circuit within the second body 42′ can be switched to display video signals of the computer host from one to another automatically thorough the third cable 47′.

Although the aforesaid KVM switch module 40′ is a convenient and popularly used KVM device, it still has the drawbacks and the shortcoming as follows:

1. For the first cable 43′, it only includes the USB connector plugs 44′ but not has any other connectors, such as PS2 connector, video connector, audio connector, etc. Besides, the second cable 45′ merely includes the video connector plugs 46′ but not has USB connector, PS2 connector, video connector, or audio connector; thus, the first cable 43′ can merely connected to the USB connector of one computer and the second cable 45′ can merely connected to the video connector of another one computer.

2. The KVM switch module 40′ restricts the user to connect the second body 42′ and the video connector plugs 46′ thereof to the display device and the corresponding computer hosts; in addition, the KVM switch module 40′ limits the user to connect the first body 42′ and the USB connector plugs 44 thereof to the keyboard and the mouse. So that, when the user uses the KVM switch module 40′, the user needs to determine which one body (the first body 41′or the second body 42′) is used for connecting to the keyboard, the mouse and the display device, and that is vey convenient for the user.

Accordingly, in view of the conventional KVM switch module still has shortcomings and drawbacks, the inventor of the present application has made great efforts to make inventive research thereon and eventually provided an improved KVM switch module.

### BRIEF SUMMARY OF THE INVENTION

The primary objective of the present invention is to provide an improved KVM switch module, in which a first cable set with various connector interfaces and a second cable set with various connector interfaces are connected to a first computer and a second computer, respectively; in addition, a third cable set is connected to a keyboard, a mouse and a display device and used for switching the keyboard, the mouse and the display device to the first cable set or the second cable set, such that the user is able to control the first computer or the second computer by the keyboard and the mouse through the first cable set or the second cable set.

The another objective of the present invention is to provide an improved KVM switch module, in which a first cable set with various connector interfaces and a second cable set with various connector interfaces are connected to a first computer and a second computer, respectively; in addition, a third cable set is connected to a keyboard, a mouse and a display device and used for switching the keyboard, the mouse, therefore, when the user uses the improved KVM switch module, the user does not need to determine which one cable set (the first cable set, the second cable set or the third cable set) is used for connecting to the keyboard, the mouse and the display device and which cable sets (the first cable set, the second cable set or the third cable set) are used for connecting to the computers.

Accordingly, to achieve the above objectives of the present invention, the inventor proposes an improved KVM switch module, comprising:

a first cable set, coupled to a first computer and having at least one first USB male connector, at least one first USB female connector, at least one first PS2 male connector, and at least one first PS2 female connector;

a second cable set, coupled to a second computer and having at least one second USB male connector, at least one second USB female connector, at least one second PS2 male connector, and at least one second PS2 female connector; and

a third cable set, coupled to the first cable set and the second cable set and electrically connected to a keyboard, a mouse and a display device; wherein the third cable set is able to switch for coupling the keyboard, the mouse and the display device to the first cable set or the second cable set.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1 is a framework diagram of a conventional KVM switch module according to the U.S. patent with application Ser. No. 12/342,244;

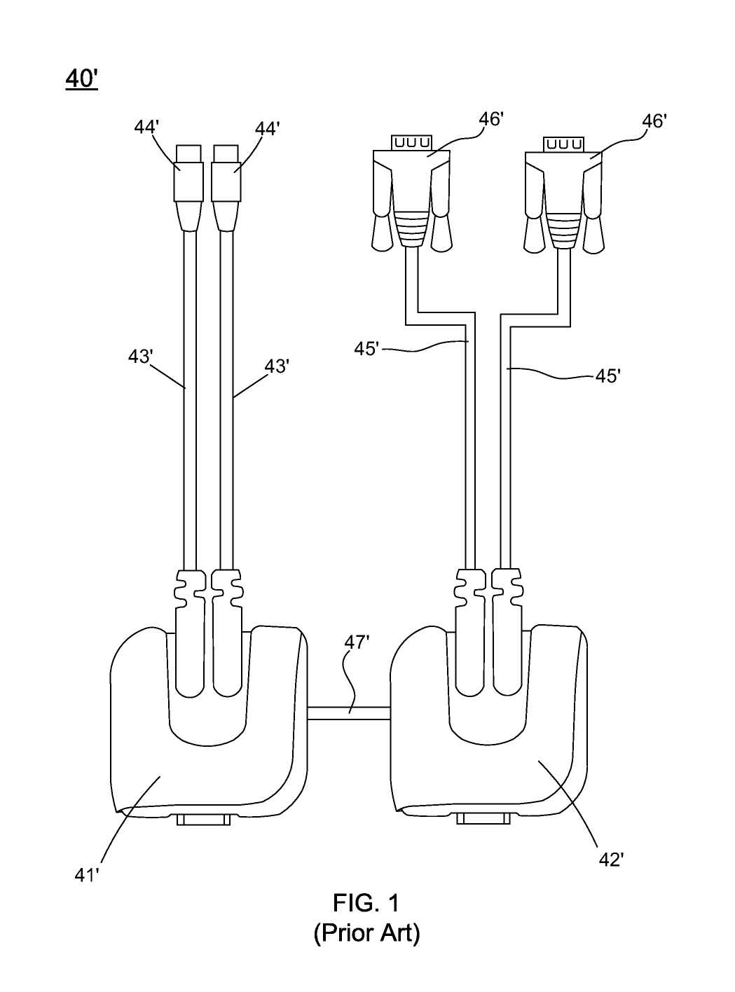

FIG. 2 is a framework view of an exemplary embodiment of an improved KVM switch module according to the present invention;

FIG. 3 is a side view of a third cable set of the improved KVM switch module according to the present invention;

FIG. 4 is a framework view of another exemplary embodiment of the improved KVM switch module according to the present invention;

FIG. 5 is a side view of a third cable set in the another exemplary embodiment of the improved KVM switch module according to the present invention.

### DETAILED DESCRIPTION OF THE INVENTION

To more clearly describe an improve KVM switch module according to the present invention, embodiments of the present invention will be described in detail with reference to the attached drawings hereinafter.

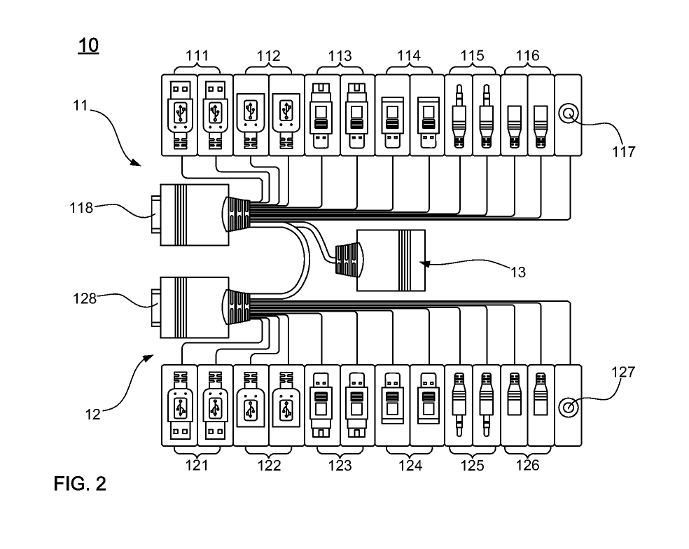

Please refer to FIG. 2, which illustrates a framework view of an exemplary embodiment of an improved KVM switch module according to the present invention. As shown in FIG. 2, the improved KVM switch module 10 includes: a first cable set 11, a second cable set 12 and a third cable set 13, wherein the first cable set 11 is coupled to a first computer (not shown) and has two first USB male connectors 111, two first USB female connectors 112, two first PS2 male connectors 113, two first PS2 female connectors 114, two first audio male connectors 115, two first audio female connectors 116, a first indicating unit 117, and a first video connector 118. Similar to the first cable set 11, the second cable set 12 is coupled to a second computer (not shown) and has two second USB male connectors 121, two second USB female connectors 122, two second PS2 male connectors 123, two second PS2 female connectors 124, two second audio male connectors 125, two second audio female connectors 126, a second indicating unit 127, and a second video connector 128.

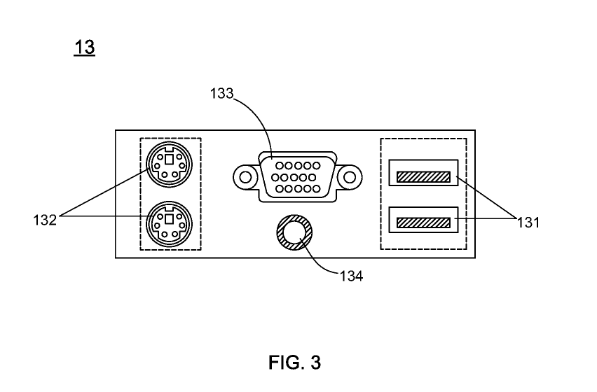

Please continuous refer to FIG. 2, and continuously referring to FIG. 3, which illustrates a side view of the third cable set of the improved KVM switch module according to the present invention. As shown in FIG. 2, the third cable set 13 is coupled to the first cable set 11 and the second cable set 12 and electrically connected to a keyboard, a mouse and a display device. As shown in FIG. 3, the third cable set 13 includes two USB connectors 131, two PS2 connectors 132 and a video connector 133 for coupling to the keyboard, the cursor control device and the display device. Moreover, the third cable set 13 further has an audio socket 134 for coupling an external audio playing device. In the improved KVM switch module of the present invention, the third cable set 13 is able to switch for coupling the keyboard, the mouse and the display device to the first cable set 11 or the second cable set 12, so as to make the user able to control the first computer or the second computer by the keyboard and the mouse through the first cable set 11 or the second cable set 12.

Moreover, because all the first cable set 11, the second cable set 12 and the third cable set 13 include the USB connectors and the PS2 connectors, the KVM switch module 10 is capable of connecting to the first computer and the second computer no matter the connector interfaces of the first computer and the second computer are USB interface or the PS2 interface. Besides, it must especially introduce that, by way of first indicating unit 117, the first cable set 11 can be indicated for being coupled to the keyboard, the cursor control device and the display device when the KVM switch module 10 is used; The same to the second cable set 12, by way of second indicating unit 127, the second cable set 12 can be indicated for being coupled to the keyboard, the cursor control device and the display device when the KVM switch module 10 is used.

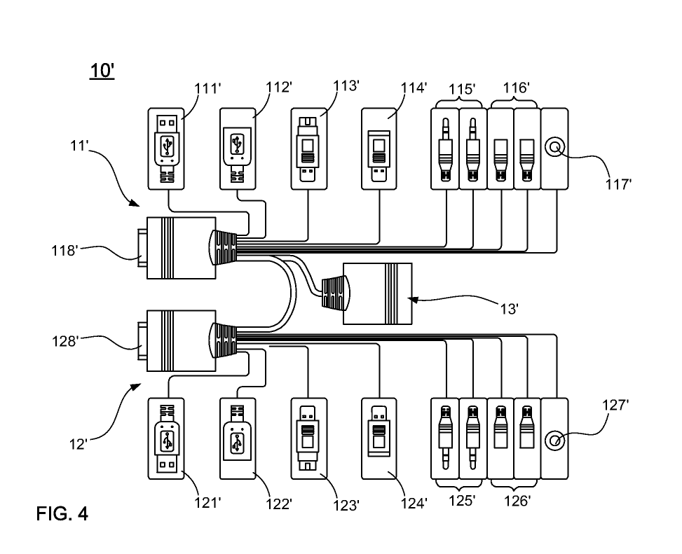

Furthermore, in the present invention, it also provides another exemplary embodiment for describing the improved KVM switch module. Please refer to FIG. 4, which illustrates a framework view of another exemplary embodiment of the improved KVM switch module according to the present invention. As shown in FIG. 4, for the another exemplary embodiment of the improved KVM switch module 10′, it includes a first cable set 11′, a second cable set 12′ and a third cable set 13′, wherein the first cable set 11′ is coupled to a first computer (not shown) and has one first USB male connectors 111′, one first USB female connectors 112′, one first PS2 male connectors 113′, one first PS2 female connectors 114′, two first audio male connectors 115′, two first audio female connectors 116′, a first indicating unit 117′, and a first video connector 118′. Similar to the first cable set 11′, the second cable set 12′ is coupled to a second computer (not shown) and has one second USB male connectors 121′, one second USB female connectors 122′, one second PS2 male connectors 123′, one second PS2 female connectors 124′, two second audio male connectors 125′, two second audio female connectors 126′, a second indicating unit 127′, and a second video connector 128′.

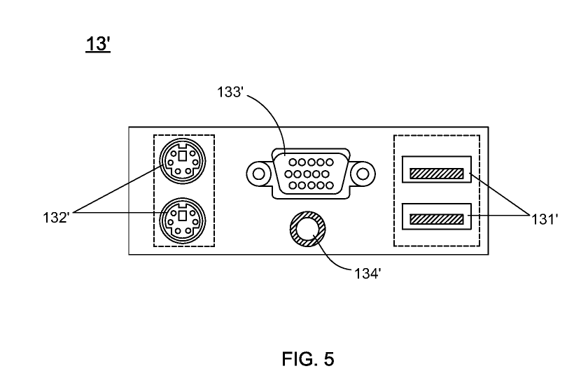

Please continuous refer to FIG. 4, and continuously referring to FIG. 5, which illustrates a side view of the third cable set in the another exemplary embodiment of the improved KVM switch module according to the present invention. As shown in FIG. 4, the third cable set 13′ is coupled to the first cable set 11′ and the second cable set 12′ and electrically connected to a keyboard, a mouse and a display device. As shown in FIG. 5, the third cable set 13′ includes two USB connectors 131′, two PS2 connectors 132′ and a video connector 133′ for coupling to the keyboard, the cursor control device and the display device. Moreover, the third cable set 13′ further has an audio socket 134′ for coupling an external audio playing device. In the improved KVM switch module of the present invention, the third cable set 13′ is able to switch for coupling the keyboard, the mouse and the display device to the first cable set 11′ or the second cable set 12′, so as to make the user able to control the first computer or the second computer by the keyboard and the mouse through the first cable set 11′ or the second cable set 12′. Moreover, because all the first cable set 11′, the second cable set 12′ and the third cable set 13′ include the USB connectors and the PS2 connectors, the KVM switch module 10′ is capable of connecting to the first computer and the second computer no matter the connector interfaces of the first computer and the second computer are USB interface or the PS2 interface.

Therefore, the above descriptions have been clearly and completely introduced the improved KVM switch module of the present invention; in summary, the present invention has the following advantages:

1. The present proposes an improved KVM switch module, in which a first cable set 11 with various connector interfaces and a second cable set 12 with various connector interfaces are connected to a first computer and a second computer, respectively; in addition, a third cable set 13 is connected to a keyboard, a mouse and a display device and used for switching the keyboard, the mouse and the display device to the first cable set 11 or the second cable set 12, such that the user is able to control the first computer or the second computer by the keyboard and the mouse through the first cable set 11 or the second cable set 12.

2. Inheriting to above point 1, moreover, when the user uses the improved KVM switch module, the user does not need to determine which one cable set (the first cable set 11, the second cable set 12 or the third cable set 13) is used for connecting to the keyboard, the mouse and the display device and which cable sets (the first cable set 11, the second cable set 12 or the third cable set 13) are used for connecting to the computers.

3. Inheriting to above point 1, furthermore, because all the first cable set 11, the second cable set 12 and the third cable set 13 include the USB connectors and the PS2 connectors, the KVM switch module 10 is capable of connecting to the first computer and the second computer no matter the connector interfaces of the first computer and the second computer are USB interface or the PS2 interface.

4. Besides, by way of first indicating unit 117, the first cable set 11 can be indicated for being coupled to the keyboard, the cursor control device and the display device when the KVM switch module 10 is used; The same to the second cable set 12, by way of second indicating unit 127, the second cable set 12 can be indicated for being coupled to the keyboard, the cursor control device and the display device when the KVM switch module 10 is used.

The above description is made on embodiments of the present invention. However, the embodiments are not intended to limit scope of the present invention, and all equivalent implementations or alterations within the spirit of the present invention still fall within the scope of the present invention.

I claim:

1. An improved KVM switch module, comprising:
a first cable set, being coupled to a first computer and having at least one first USB male connector, at least one first USB female connector, at least one first PS2 male connector, at least one first PS2 female connector, and one first video connector.
a second cable set, being coupled to a second computer and having at least one second USB male connector, at least one second USB female connector, at least one second PS2 male connector, at least one second PS2 female connector, one second video connector;
a third cable set, being coupled to the first cable set and the second cable set and electrically connected to a keyboard, a mouse and a display device;
wherein the third cable set is able to switch for coupling the keyboard, the mouse and the display device to the first cable set 11 or the second cable set.

2. The improved KVM switch module of claim 1, wherein the first cable set further comprises at least one first audio male connector and at least one first audio female connector, and the second cable set further comprises at least one second audio male connector and at least one second audio female connector.

3. The improved KVM switch module of claim 2, wherein the first cable set further comprises a first indicating unit for indicating the first cable set being coupled to the keyboard, the cursor control device and the display device, and the second cable set further comprises a second indicating unit for indicating the second cable set being coupled to the keyboard, the cursor control device and the display device.

4. The improved KVM switch module of claim 1, wherein the third cable set has two USB connectors , two PS2 connectors and a video connector for coupling to the keyboard, the cursor control device and the display device.

5. The improved KVM switch module of claim 4, wherein the third cable set further comprises an audio socket for coupling an external audio playing device.
